(19) United States
(12) Patent Application Publication
(10) Pub. No.: US 2005/0259678 A1
(43) Pub. Date: Nov. 24, 2005

(54) Network interface controller circuitry

(76) Inventor: Daniel R. Gaur, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/851,341

(22) Filed: May 21, 2004

(51) Int. Cl. H04L 12/66

(52) U.S. Cl. 370/463; 709/250

(57) ABSTRACT

In one embodiment, a method is provided. The method of this embodiment includes determining, at least in part by network interface controller circuitry, whether at least one signature that is based at least in part upon one or more respective portions of one or more respective packets is associated with at least one virus. Of course, many alternatives, variations, and modifications are possible without departing from this embodiment.

### FIELD

This disclosure relates to the field of network interface controller circuitry.

### BACKGROUND

In one conventional network arrangement, a network interface controller in a host is coupled to a network. The controller may be capable of entering a relatively low power mode of operation in which the power consumed by the controller may be less than when the controller is operating in a relatively higher power mode of operation. Thereafter, if a predetermined sequence of symbols and/or values is received by the controller via the network, the controller may detect the receipt of the sequence, and in response to the receipt of the sequence, may enter the relatively higher power mode of operation. The predetermined sequence may be static, or a program process executed in the host may be able to change the sequence.

Also in this conventional network arrangement, a virus detection program is executed by a host processor in the host. The execution by the host processor of the virus detection program results in the host processor examining data and program code stored in the host system memory and/or mass storage to determine whether the data and/or program code contains one or more predetermined sequences of values that have previously been determined to be associated with the presence of one or viruses. If the host processor detects these one or more predetermined sequences in the data and/or program code, the host processor may determine that one or more viruses are present in the data and/or program code, and may initiate action to correct this condition.

If the data and/or program code stored in the host contains one or more viruses, it is likely that the data and/or program code was initially supplied to the host via the network. Unfortunately, in this conventional arrangement, no mechanism exists to detect, at the network interface controller, one or more viruses received by the network interface controller via the network; also in this conventional arrangement, no mechanism exists to prevent one or more viruses received by the network interface controller via the network from being stored in the host's system memory and/or mass storage. Further unfortunately, in this conventional arrangement, no mechanism exists in the host to determine a source of the one or more viruses that transmitted the one or more viruses to the host via the network.

Also, after one or more viruses have been stored in the host's system memory and/or mass storage, unless the one or more viruses are removed from the host prior to being executed by the host processor, the one or more viruses may be executed by the host processor. This may result in, among other things, the network interface controller transmitting the one or more viruses to other hosts via the network. Unfortunately, in this conventional network, the network interface controller is unable to detect the presence of and/or prevent the transmission of one or more viruses in data and/or program code intended to be transmitted by the network interface controller via the network.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates a network that includes a system embodiment.

FIG. 2 illustrates the system embodiment comprised in the network of FIG. 1.

FIG. 3 is a flowchart illustrating operations that may be performed according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly, and be defined only as set forth in the accompanying claims.

### DETAILED DESCRIPTION

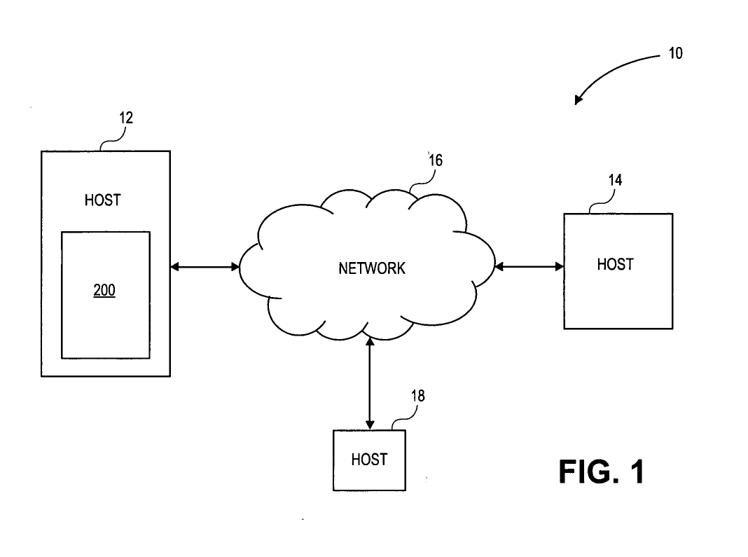

FIG. 1 illustrates one embodiment of a network 10. Network 10 may comprise hosts 12, 14, and 18 communicatively coupled together via network 16. As used herein, a first device is considered to be “communicatively coupled” to a second device, if the first device is capable of receiving from and/or transmitting to the second device one or more signals that may encode and/or represent one or more packets. Network 16 may comprise, for example, one or more local area networks and/or one or more wide area networks. Hosts 12, 14, and/or 18 may be capable of exchanging one or more packets among themselves via network 16 in accordance with one or more communication protocols. These one or more communication protocols may comprise, for example, an Ethernet protocol and/or a transmission control protocol/internet protocol (TCP/IP).

For example, if these one or more communication protocols comprise an Ethernet protocol, the Ethernet protocol may be compatible or in compliance with the protocol described in Institute of Electrical and Electronics Engineers, Inc. (IEEE) Std. 802.3, 2000 Edition, published on Oct. 20, 2000. Alternatively or additionally, if hosts 12, 14, and/or 18 are capable of exchanging one or more packets among themselves via network 16 in accordance with TCP/IP protocol, the TCP/IP protocol may comply or be compatible with the protocols described in Internet Engineering Task Force (IETF) Request For Comments (RFC) 791 and 793, published September 1981. Of course, without departing from this embodiment, hosts 12, 14, and/or 18 may be capable of exchanging one or more packets among themselves via network 16 in accordance with one or more additional and/or alternate communication protocols.

As used herein, a “packet” means one or more symbols and/or one or more values. Also as used herein, a “host” means a device capable of performing one or more logical operations and/or one or more arithmetic operations.

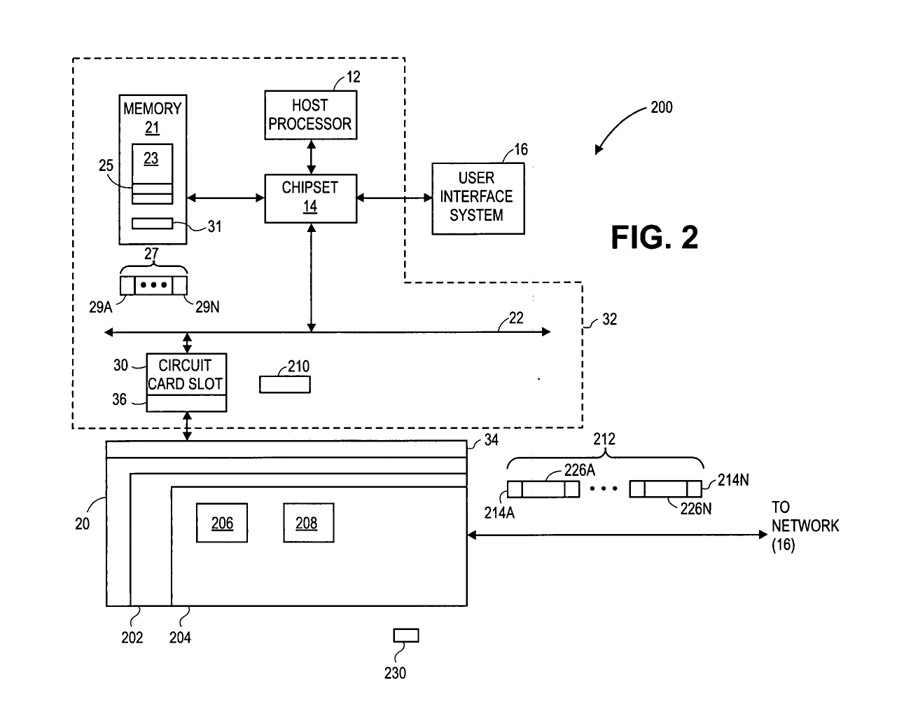

FIG. 2 illustrates a system embodiment 200 that may be comprised in host 12. System embodiment 200 may include a host processor 12 coupled to a chipset 14. Host processor 12 may comprise, for example, an Intel® Pentium® 4 microprocessor that is commercially available from the Assignee of the subject application. Of course, alternatively, host processor 12 may comprise another type of microprocessor, such as, for example, a microprocessor that is manufactured and/or commercially available from a source other than the Assignee of the subject application, without departing from this embodiment.

Chipset 14 may comprise a host bridge/hub system that may couple host processor 12, system memory 21 and user interface system 16 to each other and to bus system 22. Chipset 14 may also include an input/output (I/O) bridge/hub system (not shown) that may couple the host bridge/bus system to bus 22. Chipset 14 may comprise integrated circuit chips, such as those selected from integrated circuit chipsets commercially available from the Assignee of the subject application (e.g., graphics memory and I/O controller hub chipsets), although other integrated circuit chips may also, or alternatively be used. User interface system 16 may comprise, e.g., a keyboard, pointing device, and display system that may permit a human user to input commands to, and monitor the operation of, system 200.

Bus 22 may comprise a bus that complies with the Peripheral Component Interconnect (PCI) Local Bus Specification, Revision 2.2, Dec. 18, 1998, available from the PCI Special Interest Group, Portland, Oreg., U.S.A. (hereinafter referred to as a “PCI bus”). Alternatively, bus 22 instead may comprise a bus that complies with the PCI-X Specification Rev. 1.0a, Jul. 24, 2000, available from the aforesaid PCI Special Interest Group, Portland, Oreg., U.S.A. (hereinafter referred to as a “PCI-X bus”). Also alternatively, bus 22 may comprise other types and configurations of bus systems.

Processor 12, system memory 21, chipset 14, bus 22, and circuit card slot 30 may be comprised in a single circuit board, such as, for example, a system motherboard 32. Circuit card slot 30 may comprise a PCI expansion slot that comprises a PCI bus interface 36. Interface 36 may be electrically and mechanically mated with a PCI bus interface 34 that is comprised in circuit card 20. Slot 30 and card 20 may be constructed to permit card 20 to be inserted into slot 30. When card 20 is properly inserted into slot 30, interfaces 34 and 36 may become electrically and mechanically coupled to each other. When interfaces 34 and 36 are so coupled to each other, protocol offload engine 202 in card 20 becomes electrically coupled to bus 22.

When protocol offload engine 202 is electrically coupled to bus 22, host processor 12 may exchange data and/or commands with engine 202, via chipset 14 and bus 22, that may permit host processor 12 to control and/or monitor the operation of engine 202. Protocol offload engine 202 may comprise network interface controller (NIC) circuitry 204. NIC circuitry 204 may comprise memory 206 and processing circuitry 208. As used herein, “circuitry” may comprise, for example, singly or in any combination, analog circuitry, digital circuitry, hardwired circuitry, programmable circuitry, state machine circuitry, and/or memory that may comprise program instructions that may be executed by programmable circuitry.

Memory 21 and/or memory 206 may comprise read only, mass storage, and/or random access computer-readable memory. In operation, memory 21 may store one or more virus detection and/or correction program processes 23 and one or more operating system program processes 31. Each of program processes 23 and 31 may comprise one or more program instructions capable of being executed, and/or one or more data structures capable of being accessed, operated upon, and/or manipulated by processor 12. The execution of these program instructions and/or the accessing, operation upon, and/or manipulation of these data structures by processor 12 may result in, for example, processor 12 executing operations that may result in processor 12, system 200, and/or host 12 carrying out the operations described herein as being carried out by processor 12, system 200, and/or host 12.

Without departing from this embodiment, instead of being comprised in card 20, all or a portion of engine 202 and/or circuitry 204 may be comprised in other structures, systems, and/or devices that may be, for example, comprised in motherboard 32, coupled to bus 22, and exchange data and/or commands with other components in system 200. For example, without departing from this embodiment, chipset 14 may comprise one or more integrated circuits that may comprise all or a portion of engine 202 and/or circuitry 204. Other modifications are also possible, without departing from this embodiment.

Also, additionally or alternatively, in operation, memory 206 may store one or more program processes (not shown). Each of program processes may comprise one or more program instructions capable of being executed, and/or one or more data structures capable of being accessed, operated upon, and/or manipulated by engine 202, circuitry 204, and/or circuitry 208. The execution of these program instructions and/or the accessing, operation upon, and/or manipulation of these data structures by engine 202, circuitry 204, and/or circuitry 208 may result in, for example, processor 12 executing operations that may result in engine 202, circuitry 204, and/or circuitry 208 carrying out the operations described herein as being carried out by engine 202, circuitry 204, and/or circuitry 208.

In this embodiment, card 20 may be communicatively coupled to network 16. Card 20 may be capable of exchanging one or more packets with host 14 and/or host 18 via network 16.

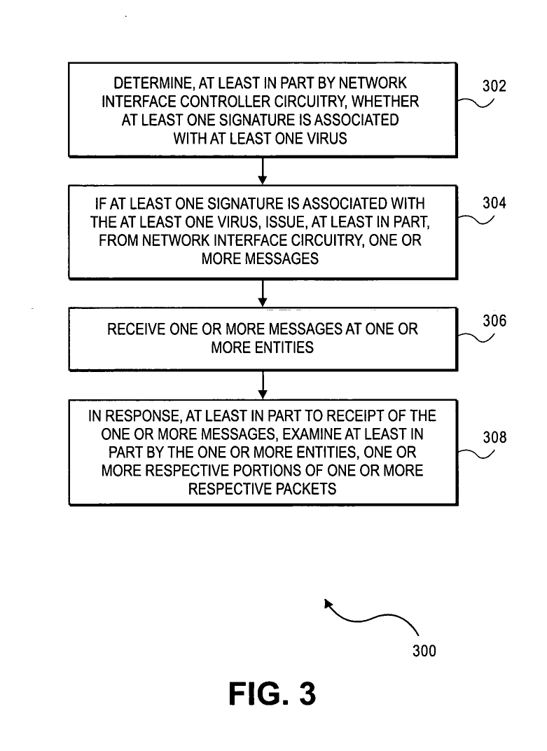

With particular reference now being made to FIG. 3, operations 300 that may be carried out in system 200 and/or network 10 in accordance with an embodiment will be described. After, for example, a reset of system 200 and/or card 20, host 14 may transmit to host 12 via network 16 one or more packets 212. One or more packets 212 may comprise one or more packets 214A, or a plurality of packets 214A . . . 214N.

One or more packets 212 may be received by card 20 from network 16. Thereafter, circuitry 208 may generate based, at least in part, upon one or more portions 226A of one or more packets 214A one or more signatures 230. As used herein, a “signature” means a set of one or symbols and/or one or more values generated based, at least in part, upon a set of one or more symbols and/or one or more values. In this embodiment, one or more signatures 230 may comprise, for example, a sequence of one or more symbols and/or one or more values comprised in one or more portions 226A (e.g., a subset of the sequence of one or more symbols and/or one or more values comprised in one or more portions 226A). Alternatively or additionally, one or more signatures 230 may comprise, for example, one or more cyclical redundancy check (CRC) values generated based at least in part upon one or more portions 226A and one or more CRC algorithms. As used herein, a “portion” of an entity may comprise some or all of the entity.

For example, in this embodiment, circuitry 208 may generate one or more signatures 230 in accordance with one or more predetermined signature generation algorithms associated with one or more viruses. These one or more signature generation algorithms may specify, for example, one or more respective portions (e.g., one or more portions 226A and/or 226N, and/or the respective sizes of one or more portions 226A and/or 226N) of one or more packets 212 upon which to perform one or more respective sets of one or more logical operations, one or more arithmetic operations, and/or one or more other forms of data manipulation (e.g., string extraction) to generate one or more signatures 230. These one or more algorithms may be empirically determined such that, if the one or more portions of one or more packets 212 specified in the one or more signature generation algorithms comprise one or more viruses, one or more signatures 230 generated by the one or more algorithms may match one or more predetermined signatures 27 that have previously been determined to be associated with the presence of one or more viruses.

For example, one or more signatures 27 may comprise one or more strings that were previously determined, via prior empirical examination (e.g., of one or more packets by one or more virus-scanning program processes), to signify presence of one or more viruses. In this example, the one or more algorithms may comprise examining one or more packets 212 to determine whether one or more portions (e.g., one or more portions 226A and/or 226N) of one or more packets 212 comprise these one or more strings, and if one or more packets 212 comprise these one or more strings, the one or more algorithms may comprise extracting, as one or more signatures 230, these one or more strings from one or more packets 212, for example, from one portion 226A of one packet 214A and another portion 226N of another packet 214N. Alternatively or additionally, the one or more algorithms may comprise, for example, generating one or more CRC checksum values for one or more packets 212, one or more packets 214A and/or 214N, and/or one or more portions 226A and/or 226N.

In this embodiment, a virus may comprise one or more instructions that when executed by a machine (such as, for example, a computer and/or processor) may result in the machine performing one or more operations whose performance may not be desired by a human operator and/or user of the machine, such as, for example, one or more malicious and/or unauthorized operations. Alternatively or additionally, in this embodiment, a virus may comprise data that when accessed and/or manipulated by a machine may result in the machine performing one or more operations whose performance may not be desired by a human operator and/or user of the machine. Also in this embodiment, one or more predetermined signatures 27 may comprise a plurality of predetermined signatures 29A . . . 29N. Each of signatures 29A . . . 29N may be associated with (e.g., the presence of) a respective virus.

In this embodiment, memory 21 may store and/or one or more processes 23 may comprise virus definition database 25. Database 25 may comprise one or more tuples (not shown). The one or more tuples may comprise a respective one of the one or more signatures 27, one or more respective viruses with which the respective one of the signatures 27 is associated, one or more respective signature generation algorithms, and one or more additional respective indicia that may indicate whether the one or more respective viruses are present in one or more portions of one or more packets 212. Circuitry 208 may generate one or more signatures 230 in accordance with these one or more signature generation algorithms, and may compare the one or more signatures 230 with the one or more signatures 27 associated with these one or more respective signature generation algorithms.

In this embodiment, prior to circuitry 208 generating one or more signatures 230, at least a portion of the data comprised in database 25 and/or predetermined signatures 29A . . . 29N may be transmitted to system 200 from host 18, via network 16. Of course, without departing from this embodiment, other techniques may be utilized to store database 25 and/or predetermined signatures 29A . . . 29N in memory 21 and/or one or more processes 23. In this embodiment, prior to circuitry 208 generating one or more signatures 230, the execution by processor 12 of one or more processes 23 may result in the one or more predetermined signature generation algorithms and/or one or more predetermined signatures 27 being transmitted from memory 21 to circuitry 204 and being stored in memory 206 for use by circuitry 208 in generating, at least in part, one or more signatures 230. Alternatively or additionally, prior to circuitry 208 generating one or more signatures 230, the execution by processor 12 of one or more processes 23 may result in a CRC seed value being transmitted from memory 21 to circuitry 204 and being stored in memory 206 for use by circuitry 208 in generating, at least in part, one or more signatures 230.

After circuitry 208 has generated one or more signatures 230, circuitry 204 and/or circuitry 208 may determine, at least in part, whether at least one signature (e.g., one or more signatures 230) that is based at least in part upon one or more respective portions 226A and/or 226N of one or more respective packets 214A and/or 214N is associated with at least one virus, as illustrated by operation 302 in FIG. 3. In this embodiment, circuitry 208 and/or circuitry 204 may perform operation 302 by comparing one or more signatures 230 with each of the one or more predetermined signatures 27. If one or more signatures 230 matches one or more of the one or more predetermined signatures 27, then circuitry 208 and/or 204 may determine, at least in part, as a result of operation 302, that one or more signatures 230 is associated with at least one virus.

If, as a result of operation 302, circuitry 204 and/or 208 determine, at least in part, that at least one signature 230 is associated with at least one virus, circuitry 204 may issue to one or more entities external to circuitry 204, such as, for example, host processor 12 and/or one or more processes 23, one or more messages 210 that may indicate that one or more signatures 230 are associated with at least one virus, as illustrated by operation 304 in FIG. 3. Host processor 12 and/or one or more processes 23 may receive one or more messages 210, as illustrated by operation 306 in FIG. 3. Thereafter, as illustrated by operation 308 in FIG. 3, in response, at least in part, to the receipt of one or more messages 210 by host processor 12 and/or one or more processes 23, host processor 12 and/or one or more processes 23 may examine one or more respective portions 226A and/or 226N of one or more respective packets 214A and/or 214N to determine whether one or more respective portions 226A and/or 226N comprise, at least in part, at least one virus. In this embodiment, as part of operation 308, host processor 12 and/or one or more processes 23 may examine one or more portions 226A and/or 226N, and/or one or more packets 212 to determine which of the respective additional criteria, associated with one or more respective viruses, in the respective tuples in database 25 may be satisfied by one or more portions 226A and/or 226N, and/or one or more packets 212. If respective additional criteria are so satisfied, processor 12 and/or one or more processes 23 may determine, as a result of operation 308, that one or more portions 226A and/or 226N comprises one or more respective viruses that may be associated with such respective additional criteria. Thereafter, one or more processes 23 and/or host processor 12 may signal one or more operating system processes 31. This may result in modification of the execution of one or more processes 31 by host processor 12 such that one or more operations may be executed by host processor 12 that may result in, for example, a human operator of system 200 being informed that at least one virus has been detected in one or more packets 212 and/or prompting the operator to authorize system 200 to take action to correct this condition.

Prior to the performing of operation 308, circuitry 204 may store in memory 206 one or more portions 226A and/or 226N, and/or one or more packets 212. In order to prevent the potential spreading of one or more viruses beyond card 20, circuitry 204 may prohibit one or more entities (such as, for example, one or more processes 31) in system 200 external to circuitry 204 from accessing (and/or executing one or more viruses that may be comprised in) one or more portions 226A and/or 226N, and/or one or more packets 212. Advantageously, this may prevent one or more viruses received by the network interface controller circuitry 204 via the network 16 from being stored in the system memory 21 and/or mass storage (not shown) in system 200, and/or from being executed by the system embodiment.

Additionally, if, as a result of operation 302, circuitry 208 and/or 204 determine that one or more signatures 230 is associated with at least one virus, circuitry 208 and/or 204 may examine, for example, header and/or network flow information comprised in one or more packets 212, and may determine, based at least in part, upon such information the source (e.g., host 14) that transmitted one or more packets 212 to system 200 via network 16.

Alternatively or additionally, circuitry 204 may be capable of generating and transmitting to a host (e.g., host 18) via network 16 one or more packets. In this arrangement, one or more packets 212 may be intended to be issued from circuitry 204 to host 18 via network 16. Prior to transmitting one or more packets 212 from circuitry 204 to network 16, circuitry 204 may store one or more packets 212 in memory 206. Circuitry 208 may generate, substantially in the manner described previously, based at least in part upon one or more portions (e.g., one or more portions 226A and/or 226N) of one or more packets 212 stored in memory 206, one or more signatures 230.

Thereafter, in this arrangement, circuitry 204 and/or 208 may perform operation 302 substantially in the manner described previously. Thereafter, if, as a result of operation 302, circuitry 204 and/or 208 determine, at least in part, that one or more signatures 230 are associated with at least one virus, circuitry 204 may issue, at least in part, one or more messages 210 to one or more processes 23 and/or host processor 12, as illustrated by operation 304. The one or more messages 210 may be received by one or more processes 23 and/or host processor 12, as illustrated by operation 306.

Thereafter, in response, at least in part, to receipt of one or more messages 210 by host processor 12 and/or one or more processes 23, host processor 12 and/or one or more processes 23 may examine one or more respective portions 226A and/or 226N of one or more respective packets 214A and/or 214N to determine whether one or more respective portions 226A and/or 226N comprise, at least in part, at least one virus. In this embodiment, as part of operation 308, host processor 12 and/or one or more processes 23 may examine one or more portions 226A and/or 226N, and/or one or more packets 212 to determine which of the respective additional criteria, associated with one or more respective viruses, in the respective tuples in database 25 may be satisfied by one or more portions 226A and/or 226N, and/or one or more packets 212. If respective additional criteria are so satisfied, processor 12 and/or one or more processes 23 may determine, as a result of operation 308, that one or more portions 226A and/or 226N comprises one or more respective viruses that may be associated with such respective additional criteria. Thereafter, one or more processes 23 and/or host processor 12 may signal one or more operating system processes 31. This may result in modification of the execution of one or more processes 31 by host processor 12 such that one or more operations may be executed by host processor 12 that may result in, for example, a human operator of system 200 being informed that at least one virus has been detected in one or more packets 212 and/or prompting the operator to authorize system 200 to take action to correct this condition. Such corrective action may comprise, for example, preventing the transmission of one or more portions 226A and/or 226N, and/or one or more packets 212 by circuitry 204 to network 16 and/or host 14, and/or further scanning of data stored in system 200 to determine whether one or more viruses are present in such data.

Thus, in summary, one system embodiment may comprise a circuit board comprising a bus interface and a circuit card capable of being inserted into the bus interface. The circuit card may comprise network interface controller circuitry capable of determining, at least in part, whether at least one signature that is based at least in part upon one or more respective portions of one or more respective packets is associated with at least one virus.

Advantageously, in this system embodiment, the network interface controller circuitry may be capable of detecting one or more viruses received by the network interface controller circuitry via the network. Also advantageously, in this system embodiment, the network interface controller circuitry may be capable of preventing one or more viruses received by the network interface controller circuitry via the network from being stored in the host's system memory and/or mass storage, and/or from being executed by the system embodiment. Further advantageously, in this system embodiment, the network interface controller circuitry may be capable of determining a source of the one or more viruses that transmitted the one or more viruses to the network interface controller circuitry via the network. Yet further advantageously, in this system embodiment, the network interface controller circuitry may also be able to detect the presence of and/or prevent the transmission of one or more viruses by the network interface controller circuitry to the network and/or to a host via the network.

The terms and expressions which have been employed herein are used as terms of description and not of limitation, and there is no intention, in the use of such terms and expressions, of excluding any equivalents of the features shown and described (or portions thereof), and it is recognized that various modifications, variations, alternatives, and equivalents are possible within the scope of the claims. Accordingly, the claims are intended to cover all such modifications, variations, alternatives, and equivalents.

1. A method comprising:
determining, at least in part by network interface controller circuitry, whether at least one signature that is based at least in part upon one or more respective portions of one or more respective packets is associated with at least one virus.

2. The method of claim 1, wherein:
if the network interface controller circuitry determines, at least in part, that the at least one signature is associated with the at least one virus, the method further comprises issuing, at least in part, from the network interface circuitry, one or more messages indicating that the at least one signature is associated with the at least one virus.

3. The method of claim 2, further comprising:
receiving the one or more messages at one or more entities external to the network interface controller circuitry; and
in response, at least in part to receipt of the one or more messages, examining at least in part by the one or more entities, the one or more respective portions of the one or more respective packets to determine whether the one or more respective portions comprise, at least in part, the at least one virus.

4. The method of claim 1, wherein:
the network interface controller circuitry is capable of receiving the one or more respective packets from a network.

5. The method of claim 1, wherein:
the network interface controller circuitry is capable of transmitting the one or more respective packets to a network.

6. The method of claim 3, wherein:
the network interface controller circuitry is capable of receiving, at least in part from the one or more entities, one or more signatures associated with the at least one virus; and
the network interface controller circuitry is capable of comparing the one or more signatures to the at least one signature.

7. The method of claim 6, wherein:
the network interface controller circuitry is capable of, prior to the examining, preventing the one or more respective portions of the one or more respective packets from being forwarded to and/or accessed by one or more other entities.

8. An apparatus comprising:
network interface controller circuitry capable of determining, at least in part, whether at least one signature that is based at least in part upon one or more respective portions of one or more respective packets is associated with at least one virus.

9. The apparatus of claim 8, wherein:
if the network interface controller circuitry determines, at least in part, that the at least one signature is associated with the at least one virus, the network interface controller is also capable of issuing, at least in part, from the network interface circuitry, one or more messages indicating that the at least one signature is associated with the at least one virus.

10. The apparatus of claim 9, further comprising:
one or more entities external to the network interface controller circuitry, the one or more entities being capable of receiving the one or more messages, the one or more entities also being capable of, in response, at least in part to receipt of the one or more messages, examining at least in part, the one or more respective portions of the one or more respective packets to determine whether the one or more respective portions of the one or more respective packets comprise, at least in part, the at least one virus.

11. The apparatus of claim 8, wherein:
the network interface controller circuitry is capable of receiving the one or more respective packets from a network.

12. The apparatus of claim 8, wherein:
the network interface controller circuitry is capable of transmitting the one or more respective packets to a network.

13. The apparatus of claim 10, wherein:
the network interface controller circuitry is capable of receiving, at least in part from the one or more entities, one or more signatures associated with the at least one virus; and
the network interface controller circuitry is capable of comparing the one or more signatures to the at least one signature.

14. The apparatus of claim 13, wherein:
the network interface controller circuitry is capable of, prior to examination of the one or more respective packets by the one or more entities, preventing the one or more respective portions of the one or more respective packets from being forwarded to and/or accessed by one or more other entities.

15. An article having one or more storage media storing instructions that when executed by a machine result in operations comprising:
determining, at least in part by network interface controller circuitry, whether at least one signature that is based at least in part upon one or more respective portions of one or more respective packets is associated with at least one virus.

16. The article of claim 15, wherein the instructions, when executed, also result in:
if the network interface controller circuitry determines, at least in part, that the at least one signature is associated with the at least one virus, issuing, at least in part, from the network interface circuitry, one or more messages indicating that the at least one signature is associated with the at least one virus.

17. The article of claim 16, wherein the instructions, when executed, also result in:
receiving the one or more messages at one or more entities external to the network interface controller circuitry; and
in response, at least in part to receipt of the one or more messages, examining at least in part by the one or more entities, the one or more respective portions of the one or more respective packets to determine whether the one or more respective portions of the one or more respective packets comprise, at least in part, the at least one virus.

18. The article of claim 15, wherein:
the network interface controller circuitry is capable of receiving the one or more respective packets from a network.

19. The article of claim 15, wherein:
the network interface controller circuitry is capable of transmitting the one or more respective packets to a network.

20. The article of claim 17, wherein:
the network interface controller circuitry is capable of receiving, at least in part from the one or more entities, one or more signatures associated with the at least one virus; and
the network interface controller circuitry is capable of comparing the one or more signatures to the at least one signature.

21. The article of claim 20, wherein:
the network interface controller circuitry is capable of, prior to the examining, preventing the one or more respective portions of the one or more respective packets from being forwarded to and/or accessed by one or more other entities.

22. A system comprising:
a circuit board comprising a bus interface; and
a circuit card capable of being inserted into the bus interface, the circuit card comprising network interface controller circuitry capable of determining, at least in part, whether at least one signature that is based at least in part upon one or more respective portions of one or more respective packets is associated with at least one virus.

23. The system of claim 22, wherein:
the circuit board comprises a bus via which the bus interface is coupled to a processor.

24. The system of claim 22, wherein:
a protocol offload engine comprises the network interface controller circuitry.

25. The system of claim 22, wherein:
the one or more respective portions comprises one portion of one packet and another portion of another packet.

26. The system of claim 22, wherein:
the at least one signature comprises a sequence of symbols and/or values comprised in the one or more respective portions.

27. The system of claim 22, wherein:
the at least one signature comprises at least one cyclical redundancy check value.

28. The system of claim 22, wherein:
the network interface controller circuitry also is capable of determining, at least in part, a source of the one or more respective packets.

29. The system of claim 28, wherein:
the source comprises a host.
